(19) United States
(12) Patent Application Publication
(10) Pub. No.: US 2009/0006183 A1
(43) Pub. Date: Jan. 1, 2009

(54) METHODS AND SYSTEMS FOR CUSTOMIZED COUPON GENERATION

(75) Inventors: Scott R. Paintin, Littleton, CO (US); Wendi Miles-Boykin, Aurora, CO (US); Dan Canning, Pembroke Pines, FL (US); Michelle Rendo, Woodcliff, NJ (US); Mike Hafer, Highlands Ranch, CO (US); Diane Robertson, Lone Tree, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 11/963,514

(22) Filed: Dec. 21, 2007

Related U.S. Application Data
(60) Provisional application No. 60/947,340, filed on Jun. 29, 2007.

(51) Int. Cl. G06Q 30/00

(52) U.S. Cl. 705/10; 705/14

(57) ABSTRACT

The invention provides various systems and methods for determining if a coupon should be offered and/or for determining the terms of such coupons based on information provided by a party to a transaction. In one exemplary embodiment, a method is provided for electronically generating coupons when performing money transfer transactions. According to the method, money transfer transaction information used to perform a money transfer transaction is provided. The money transfer transaction information is processed through a rules engine to determine a coupon offer based on the money transfer transaction information. The coupon offer is electronically generated so that it may be provided to a party to the transaction.

### PRIORITY CLAIM

This application claims priority to U.S. Provisional Application No. 60/947,340, filed on Jun. 29, 2007, entitled CUSTOMIZED COUPON GENERATION SYSTEMS AND METHODS.

### CROSS-REFERENCES TO RELATED APPLICATIONS

This application is related to co-pending U.S. application Ser. No. 11/535,353, filed Sep. 26, 2006 and Ser. No. 10/687,575, filed Oct. 15, 2003, the complete disclosures of which are herein incorporated by reference for any purpose.

### FIELD OF THE INVENTION

The present invention relates, in general, to coupon generation, and more particularly, to determining whether a coupon should be generated, as well as to determining what terms should be included in such a coupon offer.

### BACKGROUND OF THE INVENTION

Coupons have existed for many years. Typical coupons are provided in paper form, often circulated in magazines, newspapers and the like. With the advent of the Internet, some web sites exist where a consumer can download a coupon and then redeem that coupon on the Internet or at a brick and mortar store. Such coupons are generally regarded as “static”, meaning that the terms are the same for every consumer. For example, with a coupon placed in a newspaper, everyone receiving the newspaper receives the same coupon. As such, improvements in the art are needed.

### BRIEF SUMMARY OF THE INVENTION

The invention provides various systems and methods for determining if a coupon should be offered and/or for determining the terms of such coupons based on information provided by a party to a transaction. In one exemplary embodiment, a method is provided for electronically generating coupons when performing financial service transactions, such as, but not limited to, money transfer transactions. According to the method, money transfer transaction information used to perform a money transfer transaction is provided. The money transfer transaction information can be processed through a rules engine to determine a coupon offer based on the money transfer transaction information. The coupon offer can be electronically generated so that it may be provided to a party to the transaction.

The coupon may be provided in a variety of ways. For example, the coupon or discount may be displayed on a display screen, such as on a point of sale device. In another aspect, a document having the coupon offer may be printed. For example, the coupon may be printed on a transaction receipt or may be printed separately. In one embodiment, the coupon may be on a section that can be separated from the receipt by perforation. As another option, an audible message containing the coupon offer may be generated. This may be given over the phone, such as when calling into an IVR or VRU system. Other ways to provide the coupon include on a direct mail coupon, a bar code coupon, a virtual coupon, a coupon loaded to a card, a coupon loaded to a fob, a coupon loaded to and redeemable from a mobile device, coupon loaded to and printable from a mobile device, a receipt coupon a web page, by email, by an SMS message, by text message, and the like. A further option is to electronically load the coupon to a wireless device (using near field communication) so that the wireless device can subsequently wirelessly download the coupon when needed for redemption. In an alternative embodiment, the coupon may be printed from a wireless device by sending the coupon data wirelessly to a printer, or by connecting a wireless device to a computer or printer. In some cases, the coupon could be stored at other locations, such as on a presentation instrument (e.g., the magnetic stripe of a card) or on a host or server computer. When stored in this way, the coupon would be associated with the customer so that the customer can later access the virtual coupon. For example, when ready for redemption, the coupon could be read from the presentation instrument. If stored on a host computer, the point of sale device could read identifying information off of the presentation instrument, such as from a bar code, magnetic stripe, etc. and then perform a look up to see if any coupons are stored on the host. As an alternative, identifying information could be keyed into the point of sale device, such as by typing in a phone number or loyalty number. This would then be sent to the host to determine if any coupons are available. Further, a message of receipt of the coupon can be supplied to both a sender and/or a recipient of a money transfer transaction.

The money transfer transaction information may widely vary. For example, such information may include information on a send location and a receive location. Examples of receive locations include physical locations (brick and mortar stores), bank accounts, stored value or prepaid cards or accounts, a commercial client, mobile wallet, or the like. In such cases, the rules engine determines the coupon offer based on at least one of the actual or intended send location and the actual or intended receive location. A location may be any geographic area (e.g., country, state, city, designated marketing area (DMA), zip code, street, etc.), any specific money transfer location, or chain of locations.

The rules engine may also determine the coupon offer based on information such as whether a sender or a recipient is a loyalty participant, a transaction channel, a send amount, a payment vehicle, a service type, whether the sender is a first time sender, historical transaction information, a time of the money transfer transaction and the like. In some cases, the transaction channel may be a money transfer physical location, a money transfer web site location, a telephone money transfer, a mobile device money transfer or the like. Also, the payment vehicle may be cash, a credit card, a debit card, stored value or prepaid card or account, checks, travelers' checks, money orders, an ACH transaction or the like. Further, the historical transaction information may include transaction channels, amounts sent, payment vehicles, sending frequency, how recently sending has occurred, a mix of services used and the like. Also, the time of the money transfer transaction may include situations where the money transfer transaction was sent during a promotion period or during a specific time period.

In a further embodiment, the rules engine may determine the coupon offer based on a transaction amount threshold. For example, if the amount of the transaction exceeds a dollar amount (e.g., $100.00) then the rules engine may generate a coupon offer. The transaction amount threshold may be a fixed dollar amount. In an alternative embodiment, the transaction amount threshold may be used in conjunction with the send and/or the receive location to determine a coupon offer. For example, if the transaction is sent from New York and the transaction amount is over $100.00, a coupon offer is generated. Alternatively, if the transaction is actually received or intended to be received in India and the transaction amount is over $200.00, a coupon offer is generated. As such, depending on the combination of the send location, the receive location and the transaction amount threshold, a coupon offer may or may not be generated.

The coupon offer may include a variety of discounts, such as a dollar deduction, a percentage deduction and a flat fee amount. Also, the coupon offer may be redeemable with a current money transfer transaction or a subsequent money transfer transaction. The coupon offer may also be redeemable for or with a purchase from a third party.

In another aspect, the coupon offer may be limited to a qualifying money transfer service, a geographic band of money transfer locations, a geographic corridor of money transfer locations, an expiration date, or may be for one time use or for multiple uses. Other examples include rebates and sweepstakes entries.

In yet another aspect, the coupon may be in a format such as an email coupon, a text message coupon, a direct mail coupon, a bar code coupon, and/or a receipt coupon.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating a money transfer system having a customized coupon generation system, in accordance with various embodiments of the invention.

FIG. 2 is one example of a coupon that may be generated, in accordance with various embodiments of the invention.

FIG. 3 is a flow diagram illustrating a method of generating customized coupons, in accordance with various embodiments of the invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

The invention provides various systems and methods for determining whether to offer a coupon. If a coupon is generated, the systems and methods tailor or customize the coupon depending on various aspects of a financial transaction. Such offers and/or tailoring may be used in essentially any context where coupons are issued, and will find particular use in connection with a financial transaction. Such transactions can include purchases made with a variety of payment vehicles, including cash, credit, debit, stored value, prepaid accounts, checks, traveler's checks, money orders, mobile wallets, and the like. Other transactions include money transfers, loans, trades and the like. In some cases, coupons may be offered in connection with a same day or near same day payment service, such as Quick Collect® transaction from Western Union. They can also be used for drop down tie-ins of third party offers, such as a movie rental company (e.g., Blockbuster), a money transfer service, such as offered by Western Union or a third party loyalty program. For example, the coupons could be used in connection with airline miles, bonus points, and the like. Further, the third party may have a barcode or other unique code generator to produce the offer or coupon.

To offer and/or tailor the coupon, a variety of information can be evaluated and processed using a rules set, including information on the purchaser, where a purchase was made, the type of goods or services, the amount, the frequency of purchases and the like. In one exemplary embodiment, information on a money transfer may be used to determine how a coupon should be tailored. For example, the coupon may be based on the transaction corridor (indicated by the sender's “send location” and/or the receiver's actual or intended “receive location”). A location may be any geographic area (e.g., country, state, city, designated marketing area (DMA), zip code, street, etc.), any specific money transfer location, or chain of locations. Other factors that may be considered include whether the sender or receiver holds or uses a loyalty card (either from the money transfer company or a third party), current transaction information, such as transaction channel (e.g., agent location, website, telephone money transfer, mobile device or the like), send amount, fee amount, total payment amount, payment mechanism (cash, credit or debit by either network or brand, checks, traveler's checks, money orders, prepaid or stored value cards or accounts, ACH or the like), service type, and whether the sender or receiver is a first-time user. Other information that may be used to make the determination includes historical transaction information, such as transaction channels, amounts sent (high or average), fees paid (high, average, or total), payment mechanisms, sending frequency, how recently sending has occurred, and mix of products or services used. Also, the rules may evaluate whether the transaction was sent during a promotion period, during a specific time period, such as around Mother's Day or other holidays, or from a specific agent (money transfer) location or chain of locations.

The coupon provided can vary based on the degree that the relevant factors are attained. For example, depending on which and/or how many factors are attained, the coupon offer can vary in dollar or percentage deduction, flat-fee amount, qualifying service, band and/or corridor, expiration date, whether the promotional code is one-time use or multi-use and the like.

The coupon offer can be delivered directly on the sender's and/or receiver's transaction receipt (which may or may not be perforated) or may be delivered by reference on the transaction receipt, a display screen, an IVR/VRU system, a website, an e-mail, or text message to another website or IVR/VRU system. Once there, the consumer can obtain a coupon or promotional code by entering personal and/or transactional (e.g., Money Transfer Control Number (“MTCN”)) information. The coupon or promotional code also can be delivered to the sender or receiver via e-mail, text message, direct mail, bar code or the like.

In addition to money transfer coupons, the factors described above may also be used to generate a receipt copy for other promotions, such as sweepstakes entries or awards, rebate offers, premium items, and third-party offers.

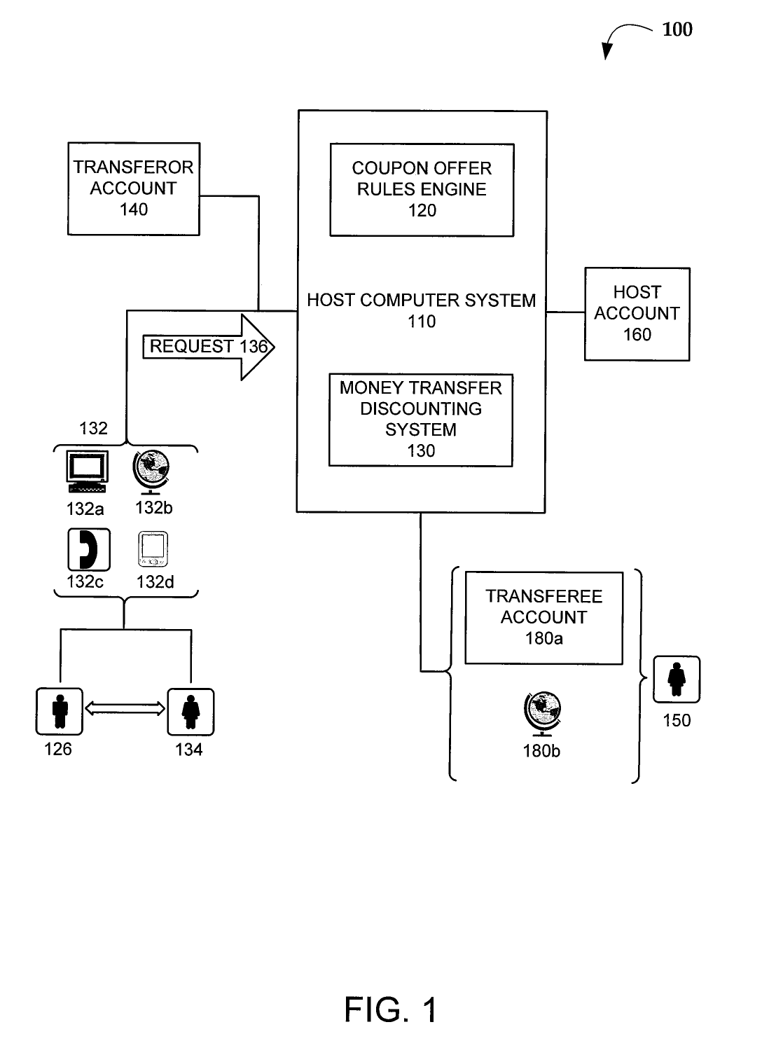

FIG. 1 illustrates a money transfer system 100 according to one embodiment of the present invention. Money transfer system 100 includes a host computer system 110, a coupon code rule engine 120, and a money transfer discounting system 130. Host computer system 110, and optionally components of host computer system 110, including coupon rules engine 120 and money transfer discounting system 130, may include, for example, mainframe computers, server computers, personal computers, workstations, web servers, or other suitable computing devices. Systems 110, 120, 130 may include application software that provide instructions for performing one or more functions according to the present invention. In some cases, systems 110, 120 and 130 may include a combination of computing devices and application software. It is appreciated that system 100 can be configured to carry out various methods of the present invention. For example, application software resident on host computer system 110 may program host computer system 110 to process money transfer requests and redemptions discussed elsewhere herein. Host computer system 110, coupon rules engine 120, and money transfer discounting system 130 may include one or more of the aforementioned computing devices, as well as storage devices such as databases, disk drives, optical drives, and the like. The storage devices may include solid state memory, such as RAM, ROM, PROM, and the like, magnetic memory, such as disc drives, tape storage, and the like, and optical memory, such as DVD, and the like. Host computer system 110 may be fully located within a single facility or distributed geographically, in which case a network may be used to integrate host computer system 110. The network may include the Internet, an intranet, a wide area network (WAN), a local area network (LAN), a virtual private network (VPN), any combination of the foregoing, or the like. The network may include both wired and wireless connections, including optical links. Many other examples are possible and apparent to those skilled in the art in light of this disclosure.

In some embodiments, host computer system 110 and other features of money transfer system 100 may be operated by a financial and communications provider such as Western Union Financial Services, Inc. Money transfers transacted via system 100 may be carried out in various ways. In one exemplary procedure, a recipient 126 (also referred to “transferor”) can use a previously generated coupon to receive a discount on a transfer fee in a money transfer transaction. In some cases, recipient 126 acts as a transferor who transfers funds to transferee 150. In other cases, recipient 126 can give a coupon to a third party 134, who can act as transferor and enjoy the benefit of the coupon.

In order to receive the discount (or have a coupon generated), recipient 126 can submit a money transfer request 136 to host computer system 110. Money transfer request 136 can be submitted via any suitable transaction device 132 (or a “transaction channel”), including for example an Internet enabled device 132a, an agent location 132b, a telephone 132c, or a point of sale (POS) device 132d. Transaction device 132 may be any of a number of devices capable of receiving a money transfer requests from a transferor. Internet enabled device 132a may include, without being limited to, a personal computer, a personal digital assistant (PDA), a mobile phone, and the like. Agent location 132b may include an office or other facility operated by or for a financial or communication service provider. For example, Western Union services are available in more than 275,000 agent locations in over 200 countries and territories around the world. When recipient 126 submits money transfer request 136 via telephone 132c, request 136 is often routed to a representative or other person who acts as an intermediary between recipient 126 and host computer system 110. For example, recipient 126 may initiate a request for a Western Union Money Transfer transaction by calling 1-800-CALL-CASH®. Alternatively recipient 126 can initiate a money transfer request 136 with host computer system 110 via an interactive voice response (IVR) system or other computerized or automated communication modality. POS device 132d may include a standard fixed retail point of sale terminal, or it may include a portable point of sale terminal.

Exemplary POS devices are discussed in U.S. Pat. No. 6,547,132, the entire disclosure of which is incorporated herein by reference for all purposes. In general terms, POS devices are terminals for receiving transaction information and sending the information to a host computer system. For example, a POS may receive transaction information by capturing it from a card using a reader integral to or associated with the POS. A POS also may receive information from an attendant or transferor via a keypad, keyboard, and/or other input device. Other examples are possible. POS devices may be located at money transfer service provider locations. POS devices such as POS device 132d may be attended or unattended.

System 100, and in some cases transaction device 132, may include one or more transaction computing devices programmed to receive money transfer information from transferors or attendants. The transaction computing device may be any of the aforementioned computing devices. Like POS device 132d, the transaction computing devices may be located at money transfer service provider locations. At such locations, the transferor can complete an appropriate money transfer form, and an attendant can enter the money transfer information. System 100 also may include one or more Customer Service Representative (CSR) computers. The CSR computers may be located, for example, at a call center operated by or for a money transfer service provider. The CSR computers may function much like POS device 132d or the aforementioned computing device, except that transaction information can be entered by a CSR who is receiving the information from a transferor by phone, for example. In some examples, a VRU system may receive some or all of the information. System 100 may also include additional types of transaction devices 132, which may be embodied by one or more unmanned transaction devices such as a multi-purpose kiosk or an automated teller machine (ATM).

Money transfer request 136 is often accompanied by a payment, or a promise of payment. Customarily, this payment is made by the transferor. Payment can be made with cash, or with a presentation instrument such as a credit card, a stored value card, a debit card, a frequent buyer card, ACH, check, traveler's check, money order, ATM card, prepaid or stored value card or account and the like. Often, the presentation instrument can be associated with an account of the recipient 126. In some embodiments, a presentation instrument may include transaction data that can be read by a Near Field Communication reader. Transaction device 132 may be configured to accept any of these payment types. In some cases, the transferor may initiate a money transfer request by providing a user name and password or other security information to transaction device 132. In some cases, transaction device 132 may prompt the transferor to input certain registration information via a personal information registration procedure so as to establish a user name and password for the transferor.

Money transfer request 136 will typically include an amount to be transferred, the identity of the transferee, an expected payout geography, a coupon code (if a coupon code is being redeemed), or any other appropriate transactional information. Other examples of money transfer transaction information may include the identity of the transferor, an address of the transferee, an address of the transferor, a location where the transfer originates, a pick up location, an identity of the agent performing the transaction, a form of payment, a time of the transfer and the like.

Once the money transfer transaction information is submitted to host 110, it is processed by rules engine 120 in order to generate a customized coupon. This coupon may be used with the current transaction or with a subsequent transaction.

Host computer system 110 may be configured to embody any of a variety of discounting schemes. For example, host computer system 110 may customize a coupon for a particular recipient 126 or group of recipients based on past interaction between host computer system 110 and a particular person or group of persons or based on the recipient's name, address, Automatic Number Identification (ANI), loyalty code or number, registration number, personal identification number (PIN), telephone number, username, password, or other identifier. An address may be a physical address such as a mailing address or post office address. An address may also be an electronic address, such as an email address, a text message address, and the like.

In one illustrative example, a sender may wish to send $100 to India. The transferor is located in the U.S. The transferor provides his name, the name of the transferee and the country (and possibly city) of the transferee. This information is transmitted to host 110 where rules engine 120 processes the information. The rules engine 120 may notice that this transferor has previously sent two other money transfers to India. As such, the rules engine 120 decides to generate a $5 coupon that may be used by the transferor the next time money is sent from the U.S. to India. The coupon would not be valid for transfers to any other country. Host 110 transmits an electronic file back to the agent location where a paper coupon is printed and given to the transferor for $5 off.

In some cases, rules engine 120 may be programmed to encourage the sending of money to a different location. For example, rules engine 120 may determine that this transferor sent money to another city in the U.S. several months ago, but has not repeated the transaction. In such a case, rules engine 120 may generate a $10 off coupon if the next transfer is all within the U.S. This is in hopes that the transferor will continue to send to India but also resume sending money in the U.S. as well. This coupon may be transmitted back to the agent location where the coupon may be printed. As another example, for any originating transfer outside of the U.S., the customer may receive a coupon for a transfer that occurs within the U.S. Other triggers may also be set. For example, a coupon may be generated for the sending of a bill payment to a commercial client, such as a mortgage lender. Still a further example may be for a prepaid transfer to a mobile phone service provider.

In the above two examples, the coupon was based on the transaction corridor. However, as described elsewhere a variety of other factors could be used to tailor a coupon to a customer (either transferor or transferee). In one embodiment, this transaction corridor may include both the send location and the receive location, or either the send location or the receive location individually.

As shown below, the coupon may be a variety of forms including a printed message. The following is a printed coupon good for a discount on a U.S. to India money transfer.

“GREAT NEWS! Take $5 OFF one Money Transfer. Valid only for US person to person transfer payable same day at Agent in India. One discount per transfer. No cash value. Agent-Use code #####-#########. Expires ##/##/##” This coupon can be for one-time use or for multiple uses.

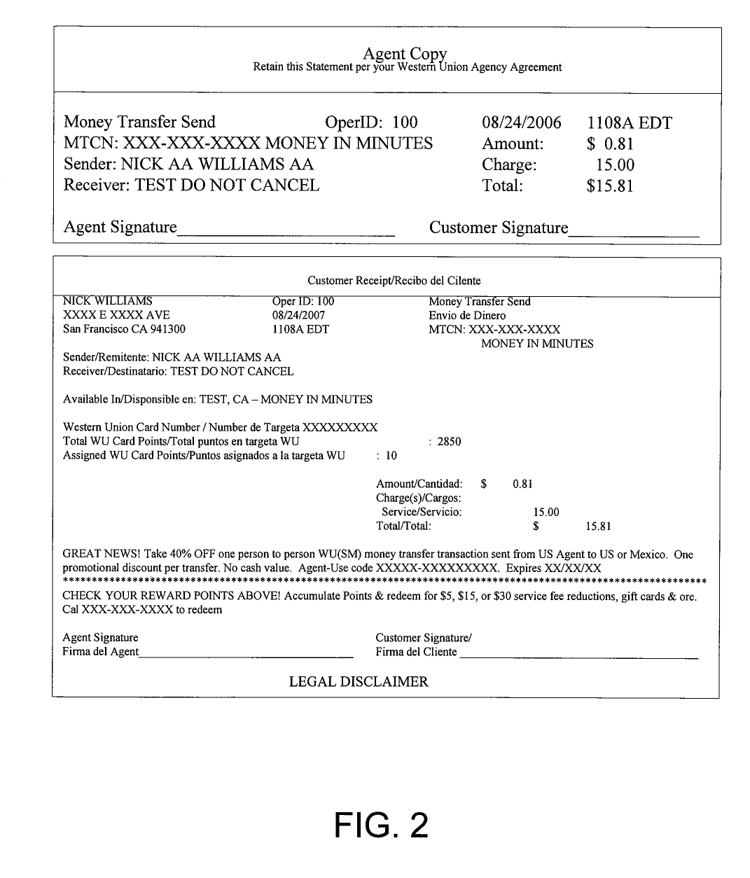

A further example of a coupon that may be provided to a transferor is illustrated in FIG. 2.

If a coupon is submitted at the time of a money transfer transaction, money transfer discounting system 130 receives money transfer request 136, and calculates a discounted money transfer fee based on the coupon. In some cases, the discount is based on a percentage of the transferred money. For example, if the money transfer amount is $100, and the coupon code provides a discount of 5% of the transferred amount, then the discount for the transfer fee is $5. Similarly, the discount may be based on a flat rate. For example, if the transfer money amount is $200, and the coupon code provides a discount of $5, then the transfer fee is discounted by $5. In relation, the discount may be based on the particular product or service being transacted. For example, the coupon code may provide a $5 discount on a money transfer fee when used in conjunction with a domestic money transfer, and may provide a $10 discount on a money transfer fee when used in conjunction with an international money transfer or may provide a 10% discount on a Quick Collect® transaction. As described above, the discount may be for a specific transfer corridor, such as between the U.S. and Mexico.

The transferred money can be made available to transferee 150 via a transferee account 180a or an agent location 180b. The transferee account 180a may include a bank account, an investment account, a retirement account, or a stored value account (e.g., a mobile wallet). The payout at the agent location 180b may be in cash, by check, payout card or combinations thereof. It is further appreciated that the transferred money may be made available to transferee 150 via a device similar to transaction device 132 discussed above. For example, transferred money may be made available to transferee 150 via an unmanned transaction device such as a kiosk or ATM, as these devices are typically configured to dispense cash, money orders, and/or other forms of value, including local currency. In some embodiments, transferee 150 may provide a presentation instrument such as a bank card or a gift card, or a Near Field Communication enabled device such as a mobile telephone, such that transferee can affect acceptance of transferred funds into transferee account 180a. Transferred money may also be made available via a POS device. In some instances, transferee 150 may use a POS device or other transaction device to redirect funds to an account or to another transferee.

With the coupon, transferee 126 wishes to transfer $100 to transferee 150. Transferee 126 submits a request to make a transaction and provides the coupon. In this instance, the coupon may be redeemed for a $5 discount to be applied against a money transfer fee. Upon receipt of the coupon, transferee 126 visits agent location 132b and submits a request to transfer $100. The standard transfer fee rate is 15% of the transferred amount, so in this case the standard transfer fee is $15. In sum, the total undiscounted amount to be charged to transferee is $115. Transferee 126 presents agent location 132b with the coupon to receive the discount of $5, which is subtracted from the $15 transfer fee. Thus, the discounted transfer fee is $10, and the total discounted cost to transferee is $110. All or part of the total discounted cost of $110 can be withdrawn from a transferor account 140, which may include a checking, savings, or credit (or stored value) account. Similarly, all or part of the total discounted cost of $110 may be paid directly to agent 132b via cash or other suitable legal tender. Of the total discounted cost of $110, the $100 money transfer can be routed to transferee account 180a or agent location 180b, and the $10 discounted transfer fee can be routed to host account 160 or to an agent account and later transferred from the agent account to a host account.

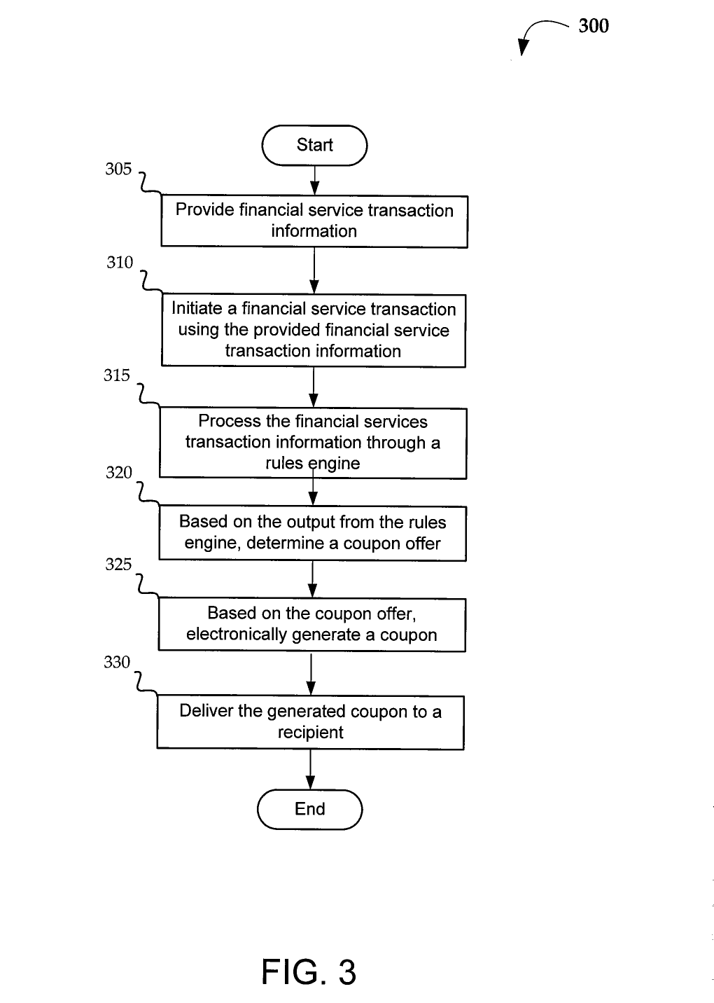

Turning now to FIG. 3, which illustrates a method 300 for generating customized coupons according to aspects of the present invention. At process block 305, financial service transaction information may be provided. Such financial transaction information may include, for example, the identity of the individual initiating the transaction (the transferor), information about the recipient of the transaction (the transferee), the origination and/or destination location of the transaction, the amount of the transaction, etc.

At process block 310, using the provided financial service transaction information, a financial service transaction may be initiated. In one embodiment, the transaction may be an electronic transaction (e.g., an electronic funds transfer (EFT), a wire transfer, a money transfer, etc.). At process block 315, the financial services transaction information may be processed through a rules engine (e.g., coupon offer rules engine 120 in FIG. 1).

At process block 320, based on the output generated by the rules engine, a coupon offer may be determined. The coupon offer may provide a variety of discount and/or reduced fee options for various products and/or services. Furthermore, based on the generated coupon offer, a coupon may be electronically generated (process block 325). The coupon may be generated in a variety of formats (e.g., printed, an email, a fax, a text message, a voice recording, writing to a card or other device, etc.). At process block 330, the generated coupon may be delivered to the transferee using various delivery methods.

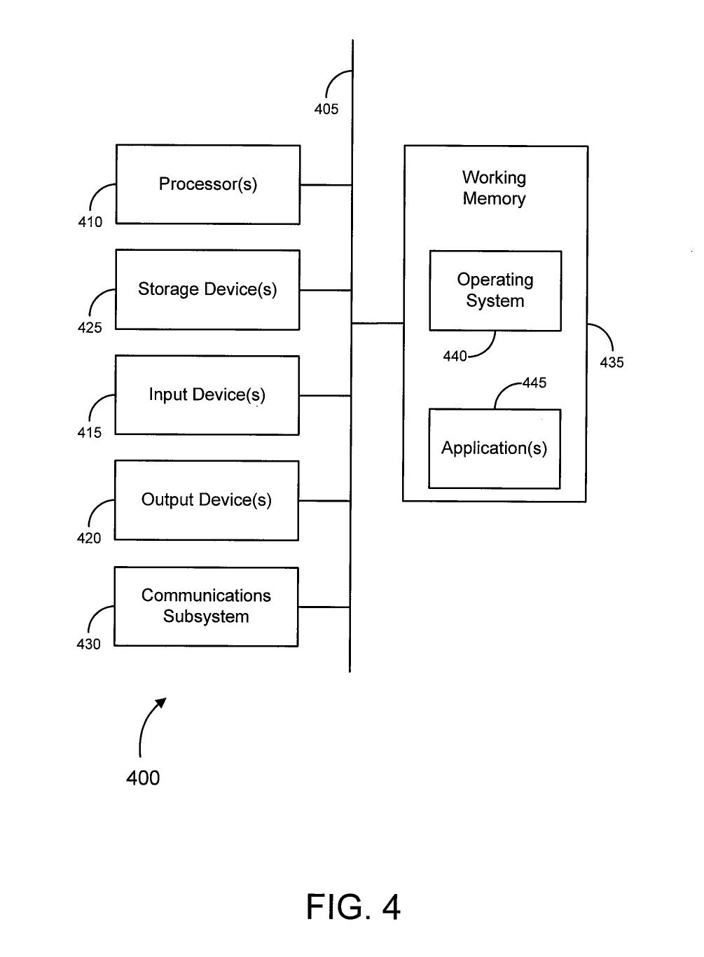

FIG. 4 provides a schematic illustration of one embodiment of a computer system 400 that can perform the methods of the invention, as described herein, and/or can function as, for example, host computer 110 in FIG. 1. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (e.g., a removable medium, such as a compact disc, etc.), and or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation, dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

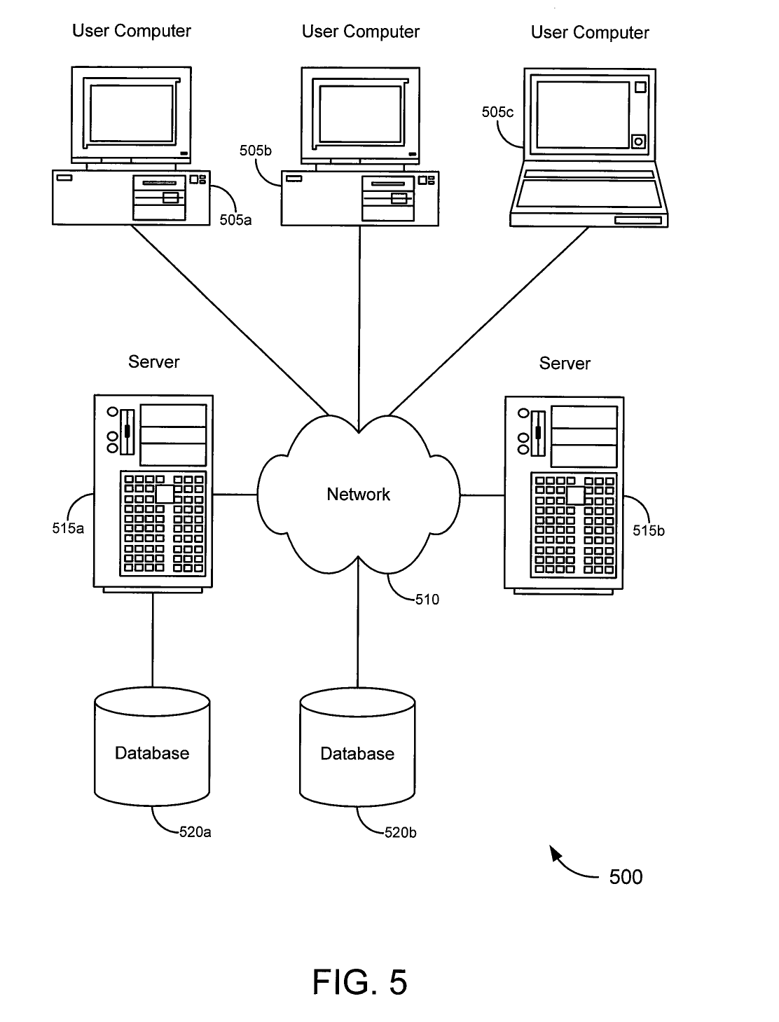

A set of embodiments comprises systems for generating customized coupons. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ (e.g., Vista™) and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 5 10. The network 510 can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 505 and/or another server 515. In some embodiments, an application server can create web pages dynamically for displaying the information in accordance with embodiments of the invention, such as a web interface for transaction devices 132a-d in FIG. 1. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases, a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for electronically generating rebates when performing financial service transactions, the method comprising:
providing financial service transaction information used to perform a financial service transaction;
processing the financial service transaction information through a rules engine to determine a rebate offer based on the financial service transaction information; and
electronically generating a rebate based on the rebate offer, wherein the rebate is configured to allow a customer to receive at least a portion of a transaction fee back after paying the transaction fee.

2. A method as in claim 1, wherein the financial service transaction comprises a money transfer and the financial service transaction information includes information on a send location and a receive location of the financial service transaction, and wherein the rules engine determines the rebate offer based, at least in part, on the send location and the receive location.

3. A method for electronically generating coupons when performing financial service transactions, the method comprising:
providing financial service transaction information used to perform a financial service transaction, wherein the financial service transaction information includes information on a transaction corridor comprising a send location and a receive location associated with the financial services transaction;
processing the transaction corridor through a rules engine to determine a coupon offer based, at least in part, on the transaction corridor; and
electronically generating a coupon based on the coupon offer.

4. A method as in claim 3, wherein the rules engine determines the coupon offer based on both the send location and the receive location.

5. The method of claim 3, wherein the financial service transaction comprises a money transfer transaction.

6. A method as in claim 3, further comprising at least one of displaying the coupon on a display screen, printing a document having the coupon, generating an audible message containing the coupon, sending an e-mail of the coupon, sending a text message of the coupon, writing the coupon to a card, writing the coupon to a fob, creating a virtual coupon, and providing the coupon through a website.

7. A method as in claim 3, wherein the coupon includes at least one of a dollar deduction, a percentage deduction and a flat fee amount.

8. A method as in claim 6, wherein the coupon is redeemable with a current money transfer transaction or a subsequent money transfer transaction.

9. A method as in claim 3, wherein the coupon is limited to at least one of a qualifying money transfer service, a geographic band of money transfer locations, a specific money transfer location, a chain of money transfer locations, a geographic corridor of money transfer locations, an expiration date, for one time use, and for multiple uses.

10. A method as in claim 3, wherein the rules engine determines the coupon offer based on at least one of whether a sender or a recipient is a loyalty participant, a transaction channel, a send amount, a send fee, a payment vehicle, a specific money transfer location, a chain of money transfer locations, a service type, whether the sender is a first time sender, historical transaction information, and a time of the money transfer transaction.

11. A method as in claim 10, wherein the transaction channel includes at least one of a money transfer physical location, a money transfer web site location, a telephone money transfer, a kiosk, an automated teller machine (ATM), and a mobile device money transfer.

12. A method as in claim 10, wherein the payment vehicle includes at least one of cash, a credit card, a debit card, a stored value card, a prepaid card, an account, a check, a money order, a traveler's check, and an ACH transaction.

13. A method as in claim 10, wherein the historical transaction information includes at least one of transaction channel(s), amount(s) sent, send fee(s), payment vehicles, a specific money transfer location, a chain of money transfer locations, sending frequency, and how recently the sending occurred.

14. A method as in claim 10, wherein the time of the money transfer transaction includes at least one of whether the money transfer transaction was sent during a promotion period, and during a specific time period.

15. A method as in claim 3, further comprising providing the coupon in a format comprising at least one of an email coupon, a text message coupon, a direct mail coupon, a bar code coupon, a virtual coupon, a coupon loaded to a card, a coupon loaded to a fob, a coupon loaded to and redeemable from a mobile device, coupon loaded to and printable from a mobile device, and a receipt coupon.

16. A method as in claim 3, wherein the coupon is an offer for at least one of, a rebate offer, a premium item offer, and a third-party offer.

17. A method as in claim 12, wherein the coupon is at least one of a sweepstakes entry or a sweepstakes award.

18. A system for electronically generating coupons when performing financial service transactions, the system comprising:
a host computer that is configured to receive financial service transaction information used to perform a financial service transaction, wherein the financial service transaction information includes information on a transaction corridor comprising a send location and a receive location associated with the financial services transaction, to process the transaction corridor through a rules engine to determine a coupon offer based on the transaction corridor, and to electronically generate a coupon based on the coupon offer.

19. A system as in claim 18, further comprising:
a printing device coupled with the host computer, that is configured to print the coupon.

20. A system as in claim 19, further comprising:
a display device coupled with the host computer, that is configured to display the coupon.

21. A system as in claim 18, wherein the host computer further comprises a money transfer discounting system that is configured to calculate a discounted money transfer fee for the money transfer based on the coupon.

22. A method for electronically generating coupons when performing financial service transactions, the method comprising:
providing financial service transaction information used to perform a financial service transaction, wherein the financial service transaction includes a transaction amount, and wherein the financial service transaction information includes information on a send location and a receive location associated with the financial services transaction;
determining that the transaction amount exceeds a transaction amount threshold;
processing the send location or the receive location through a rules engine to determine a coupon offer based on the send location or the receive location and the determination that the transaction amount exceeds the transaction amount threshold; and
electronically generating a coupon based on the coupon offer.

23. A method as in claim 22, wherein the financial service transaction information includes the send location and the receive location associated with the financial service transaction, and wherein the coupon offer is determined based on the send location, the receive location, and the determination that the transaction amount exceeds the transaction amount threshold.

24. A method as in claim 22, wherein the transaction amount threshold is a fixed dollar amount.

25. A machine readable medium having a set of instructions stored thereon which, when executed by a machine, cause the machine to:
provide financial service transaction information used to perform a financial service transaction, wherein the financial service transaction information includes information on a transaction corridor comprising a send location and a receive location associated with the financial services transaction;
process the transaction corridor through a rules engine to determine a coupon offer based on the transaction corridor; and
electronically generate a coupon based on the coupon offer.
